(19) United States
(12) Patent Application Publication
(10) Pub. No.: US 2016/0374161 A1
(43) Pub. Date: Dec. 22, 2016

(54) LED LIGHTING APPARATUS

(71) Applicant: Posco LED Company Ltd., Yongin-si (KR)

(72) Inventors: Sang Hyuk KIM, Yongin-si (KR); Jung Hwa KIM, Yongin-si (KR); Dae Won KIM, Yongin-si (KR)

(21) Appl. No.: 14/743,795

(22) Filed: Jun. 18, 2015

(51) Int. Cl. H05B 33/08; F21V 23/00; F21V 29/67

(52) U.S. Cl. CPC H05B 33/0815; F21V 29/67; F21V 23/004

(57) ABSTRACT

A light emitting diode (LED) lighting apparatus may include: a power supply unit configured to provide a constant DC current; a light emitting module comprising a printed circuit board (PCB) and a plurality of LEDs disposed on a first side of the PCB, wherein the lighting emitting module is configured to receive the constant direct current (DC) current; and a fan module configured to receive a constant DC voltage from the light emitting module, wherein the constant DC voltage is a sum of the forward voltages of at least two LEDs of the plurality of LEDs.

### BACKGROUND

Field

Exemplary embodiments relate to a light emitting diode (LED) lighting apparatus. More particularly, exemplary embodiments relate to a LED lighting apparatus emitting a plane shape light.

Discussion of the Background

A light emitting diode (LED) is a semiconductor element that may be made of a material, such as gallium (Ga), phosphorus (P), arsenic (As), indium (In), nitrogen (N), aluminum (Al), etc. The LED may emit any suitable color, such as red, green, blue, etc., light when a current is applied. As compared with a fluorescent lamp, the LED may have a relatively longer lifespan, a relatively faster response speed when excited (e.g. time until light is emitted after a current flows), and a relatively lower power consumption. Due, at least in part, to these advantages, the LED use is increasing. Accordingly, LEDs have found use in various kinds of lighting apparatus, such as bulbs, tubes, recessed lights, and street lamps, etc.

For example, a lighting apparatus employing an LED element (LED lighting apparatus) is increasingly being used as a factory lighting fixture in industrial workplaces which require high light output as well as being used an indoor lamp in homes and offices.

However, such a LED lighting apparatus (e.g. factory lighting fixture) generates large amounts of heat during operation of a light emitting module including the LED elements.

In order to decrease heat from the light emitting module, the conventional LED lighting apparatus may include a fan which cools down the light emitting module.

However, voltage for the fan in the conventional LED lighting apparatus is typically supplied from a power supply unit, and the fan typically connects with the power supply unit using an additional power lines. Because of this, a structure of the LED lighting apparatus may become relatively complicated, and the weight and the size of the LED lighting apparatus also may increase.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a LED lighting apparatus including a light emitting module including a plurality of LEDs disposed on a printed circuit board (PCB). The PCB has power patterns electrically coupled to the LEDs and power terminals electrically coupled between the power patterns and a connection wires with a fan. Thus, the fan may be applied a constant voltage through the power patterns according to a sum of the forward voltages of LEDs coupled to the power patterns. Therefore, a structure of the LED lighting apparatus may become less complicated, and the weight and the size of the LED lighting apparatus also may decrease.

Additional aspects will be set forth in the detailed description which follows, and, in part, will be apparent from the disclosure, or may be learned by practice of the inventive concept.

According to exemplary embodiments, a light emitting diode (LED) lighting apparatus may include: a power supply unit configured to provide a constant direct current (DC) current; a light emitting module comprising a printed circuit board (PCB) and a plurality of LEDs disposed on a first side of the PCB, wherein the light emitting module is configured to receive the constant DC current; and a plurality of LEDs disposed on a first side of the PCB; and a fan module configured to receive a constant DC voltage from the light emitting module, wherein the constant DC voltage is a sum of the forward voltages of at least two LEDs.

The power supply unit may include a switching mode power supply (SMPS) converting alternating current (AC) voltage into DC voltage, and a light emitting driving controller maintaining a DC current applied to the light emitting module constantly.

The SMPS may include an AC/DC converter converting an AC voltage from an external source to a DC voltage, and a DC/DC converter converting the converted DC voltage to a first DC voltage.

The light emitting driving controller may be electrically coupled to the DC/DC converter and maintains the constant DC current applied to the light emitting module by controlling the first DC voltage.

The PCB may be a metal core PCB (MCPCB) or metal PCB (MPCB) based on a metal board.

The plurality of LEDs (1^{st} LED, 2^{nd} LED, . . . , n^{th} LED) may be connected in series each other.

The PCB may have a positive (+) input power terminal and a negative (−) input power terminal are electrically coupled to the power supply unit.

The positive (+) input power terminal may be electrically coupled to an anode electrode of the first LED (1^{st} LED) through a first input power pattern formed on the PCB, and the negative (−) input power terminal may be electrically coupled to a cathode electrode of the last LED (n^{th} LED) through a second input power pattern formed on the PCB.

The first and second input power patterns may be formed on a second side of the PCB.

The PCB may have a positive (+) output power terminal and a negative (−) output power terminal are electrically coupled to a fan in the fan module.

The positive (+) output power terminal may be electrically coupled to an anode electrode of the first LED (1^{st} LED) through a first output power pattern formed on the PCB, and the negative (−) output power terminal may be electrically coupled to a cathode electrode of j^{th} (1<j≦n) LED through a second output power pattern formed on the PCB.

The first and second output power patterns may be formed on a second side of the PCB.

A sum of the forward voltages from the 1^{st} LED to the j^{th} LED may apply to the fan module through the output power terminals and the output power patterns.

The sum of the forward voltages may be the constant DC voltage applied to the fan.

The voltage level of the sum of the forward voltages may be higher than the level of the working voltage of the fan.

The plurality of LEDs may be disposed apart from each other on the first side of the PCB, and electrically coupled to each other with circuit patterns formed on a second side of the PCB.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating operation of a LED lighting apparatus according to a first exemplary embodiment.

FIG. 2 is a block diagram illustrating operation of a LED lighting apparatus according to a second exemplary embodiment.

FIG. 3 is a block diagram illustrating connection with a power supply unit, a fan module, and a light emitting module shown in FIG. 2 according to the second exemplary embodiment.

FIG. 4 is a schematic plan view illustrating a PCB including LEDs, power patterns, and power terminals according to the second exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments of the present invention will be described in detail with reference to the accompanying drawings.

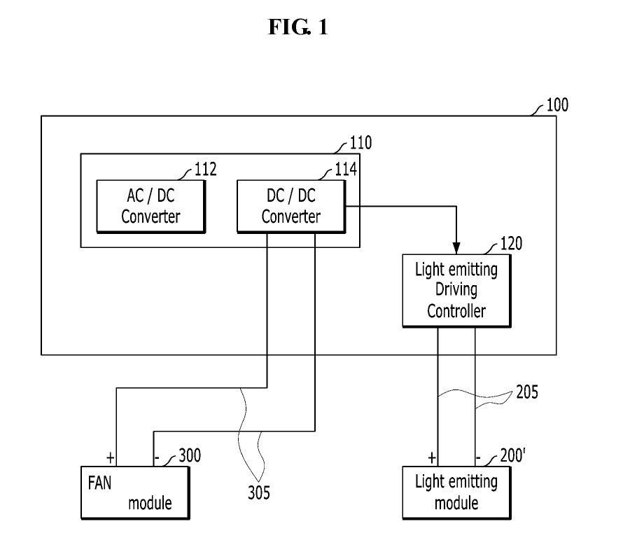

FIG. 1 is a block diagram illustrating operation of a LED lighting apparatus according to a first exemplary embodiment.

Referring to FIG. 1, the LED lighting apparatus according to a first exemplary embodiment includes a power supply unit 100, a light emitting module 200′, and a fan module 300.

The power supply unit 100 may include a switching mode power supply (SMPS) 110 and a light emitting driving controller 120. Furthermore, the SMPS 110 may include an AC/DC converter 112 converting an AC voltage from an external source to a DC voltage, and a DC/DC converter 114 converting the DC voltage converted by the AC/DC converter 112 to a proper DC voltage to drive the light emitting module 200′ and the fan module 300. The light emitting driving controller 120 coupled with the SMPS 110 and the light emitting driving controller 120 may maintain the constant DC current applied to the light emitting module 200′ by controlling the DC voltage converted by the DC/DC converter 114.

The power supply unit 100 may connect with the light emitting module 200′ through first power lines 205, so that the constant DC current from the power supply unit 100 may be applied to the light emitting module 200′. Also, the power supply unit 100 may connect with the fan module 300 through second power lines 305, so that the constant DC voltage from the power supply unit 100 may be applied to the fan module 300. That is, the light emitting module 200′ and the fan module 300 may be connected separately to the power supply unit 100.

The light emitting module 200′ may include a plurality of LEDs (not shown) having a various type of electrical connections thereof. That is, the LEDs may be coupled in series, in parallel, or series-parallel in accordance with an application applying the LEDs.

The fan module 300 may include a fan (not shown) having a plurality of rotor blades and a driving motor, and the fan typically receives constant DC voltage from the power supply unit 100. Since the fan receives voltage from the power supply unit 100, the fan will typically connect with the power supply unit 100 by an additional connecting wire, that is, the second power lines 305.

In this manner, a structure of the LED lighting apparatus according to the exemplary embodiment in FIG. 1 may become relatively complicated, and the weight and the size of the LED lighting apparatus also may increase.

Accordingly, in order to overcome such a problem, another exemplary embodiment in accordance with the inventive concept provides a light emitting module comprising a plurality of LEDs disposed on a printed circuit board (PCB). The PCB may have power patterns electrically coupled to the LEDs and power terminals electrically coupled between the power patterns and a connection wires with a fan, so that length of the connecting wire to the fan can be much shorter than the second power lines as illustrated in FIG. 1.

Thus, the fan can be applied a constant voltage through the power patterns according to a sum of the forward voltages of LEDs coupled to the power patterns, and a structure of the LED lighting apparatus can become less complicated, and the weight and the size of the LED lighting apparatus also can decrease.

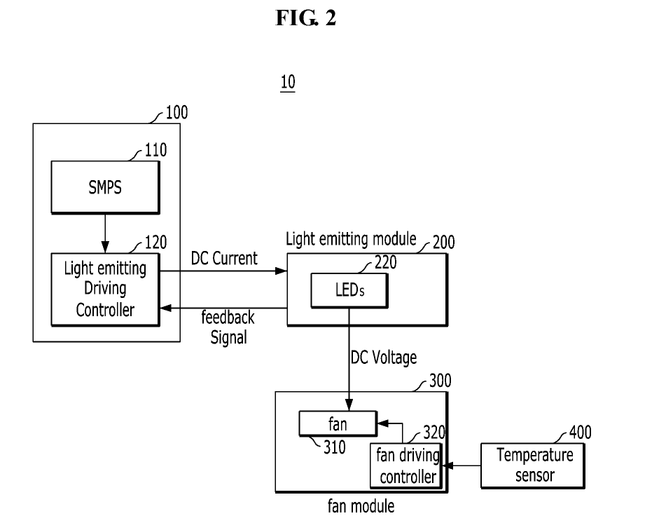

Hereinafter, another exemplary embodiment of this invention will be described in detail with reference to FIGS. 2 through 4.

FIG. 2 is a block diagram illustrating operation of a LED lighting apparatus according to a second exemplary embodiment.

Referring to FIG. 2, the LED lighting apparatus 10 according to the second exemplary embodiment also includes a power supply unit 100, a light emitting module 200, a fan module 300, and a temperature sensor 400.

The power supply unit 100 provides power (e.g. DC current) to the light emitting module 200. The power supply unit 100 may include the SMPS 110 which serves to convert AC voltage into DC voltage, and the light emitting driving controller 120 which maintains the DC current applied to the light emitting module 200 in a constant manner.

The LED element is a semiconductor device which emits light and the light output of the LED element is determined by the forward current. However, the current-voltage characteristic curve of the LED element may show a very large change in the forward current based upon a small change in the voltage according to the forward current. For this reason, the power supply unit 100 is required to supply a constant current to correspond to the desired load and not change the output voltage. Therefore, the power supply unit 100 may include a LED driving circuit including a constant current source circuit in order to apply constant DC current as the forward current to generate a uniform brightness for a plurality of LEDs in the light emitting module 200.

As shown in FIG. 2, a light emitting driving controller 120 may work as the LED driving circuit to apply a constant DC current to the LEDs 220 in the light emitting module 200. The light emitting driving controller 120 may be included in the power supply unit 100 as shown FIG. 2, and the light emitting driving controller 120 may receive a feedback signal from the light emitting module 200.

That is, the power supply unit 100 may include SMPS 110 that converts an AC voltage into a DC voltage determined by the driving voltage of the light emitting module 200, and the light emitting driving controller 120 maintains the DC constant current applied to the LEDs 220 in the light emitting module 110.

In this case, the SMPS 110 and the light emitting driving controller 120 may be integrally formed within one body with the power supply unit 100. Alternatively, each of the SMPS 110 and the light emitting driving controller 120 may be separate.

The light emitting module 200 may include printed circuit board (PCB) (not shown) and a plurality of LEDs 220 disposed on the PCB. The PCB may be a metal core PCB (MCPCB) or metal PCB (MPCB) based on a metal board having good thermal conductivity. The LEDs 220 are disposed apart from each other on the one side of the PCB, and generate light based on driving current from the power supply unit 100. The LED element is capable of generating light having various wavelengths according to the use thereof, for example, red, yellow, blue, ultraviolet, etc.

The fan module 300 may include a fan 310 and a fan driving controller 320. The fan 310 may be disposed in the inner space of case body (not shown) of the LED lighting apparatus 10. The fan 310 may draw relatively cool ambient air through an air inlet (not shown) of the case body and directs the cooling air toward the heat sink (not shown) located on the light emitting module 200.

The fan 310 may include a fan case that is open at upper and lower portions, a central axis disposed in the middle of the fan case, a plurality of rotor blades disposed in the fan case to rotate on the central axis, and a driving motor.

RPM (revolutions per minute) of the fan 310 may be controlled according to the ambient air temperature. That is, when the ambient air temperature is higher than a reference temperature, the RPM of the fan 310 may increase in order to maintain a suitable temperature of the light emitting module. In contrast, when the ambient air temperature is lower than the reference temperature, the RPM of the fan may remain constant or decrease because the temperature of the light emitting module is not so high as to require being cooled down artificially. The fan driving controller 320 may control rotation speed of the fan according to the temperature information provided by a temperature sensor 400.

The fan module 300 also may include a fan driving controller 320 controlling rotation speed of the fan 310 according to temperature information provided by a temperature sensor 400.

The temperature sensor 400 may be disposed in the inner space of a case body of the LED lighting apparatus. More specifically, the temperature sensor 400 may be located adjacent to the outer surface of the case body to sense the ambient air temperature.

That is, the rotation speed of the fan 310 can be increased when the temperature sensed by the temperature sensor 400 is higher than a reference temperature.

Also, voltage for the fan 310 may be applied as a constant DC level. As described above, each of the LEDs 220 is a semiconductor device which emits light, and the light output of the LED element is determined by the forward current. In this exemplary embodiment, the forward current is the constant DC current generated by light emitting driving controller 120 in the power supply unit 100. Thus, when the each of the LEDs 220 emits light by the constant DC current (forward current), a constant DC voltage (forward voltage, Vf) is generated at the each of the LEDs 200. Therefore, as illustrated in FIG. 2, a sum of the forward voltages of LEDs 220 may be applied to the fan 310 as the constant DC voltage.

That is, according to this exemplary embodiment, the power supply unit 100 may apply the constant DC current to the LEDs 220 in the light emitting module 200, and may not apply the DC voltage to the fan 310 in the fan module 300 directly.

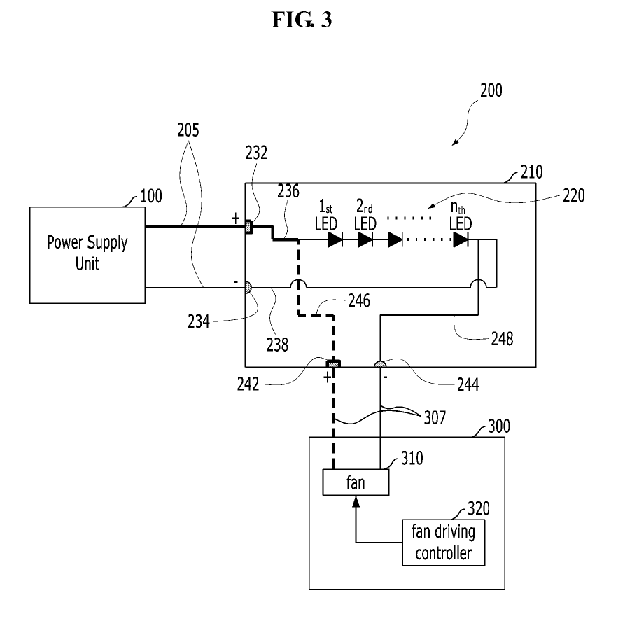

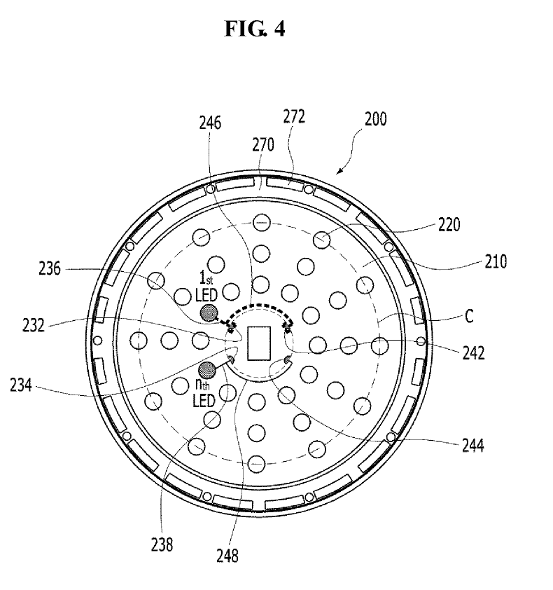

FIG. 3 is a block diagram illustrating connection with a power supply unit, a fan module, and a light emitting module shown in FIG. 2 according to the second exemplary embodiment, and FIG. 4 is a schematic plan view illustrating a PCB including LEDs, power patterns, and power terminals according to the second exemplary embodiment.

Referring to FIG. 3, the LED lighting apparatus according to a second exemplary embodiment includes a power supply unit 100, a light emitting module 200, and a fan module 300.

In this exemplary embodiment, components identical to those of the aforementioned embodiment are designated by like reference numerals, and their detailed descriptions are not repeated to avoid redundancy. Since the power supply unit 100 and fan module 300 are the same as the power supply unit and the fan module in FIG. 2, their detailed descriptions are not repeated.

The light emitting module 200 may include printed circuit board (PCB) 210 and a plurality of LEDs 220 disposed on the PCB 210.

The LEDs (1^{st} LED, 2^{nd} LED, . . . , n^{th} LED) 220 may be connected in series as shown in FIG. 3. However, this is merely one embodiment, and the present invention is not necessarily limited thereto.

As shown in FIG. 4, the PCB 210 may be a circular shape. The LEDs 220 may be disposed apart from each other on the one side (e.g. lower side) of the PCB 210, and electrically coupled to each other regardless of the distance with circuit patterns (not shown) formed on the other side (e.g. upper side) of the PCB 210. The LEDs 220 may be arranged along a periphery of the PCB 210 on a circle (C) indicated by a dash-dot-dotted line and the plural LEDs 220 are arranged over most regions within the circle (C). In a central region of the PCB 210, the LEDs 220 are not placed in order to provide space for components, power terminals 232, 234, 242, 244, and power patterns 236, 238, 246, 248.

The PCB 210 may be a metal core PCB (MCPCB) or metal PCB (MPCB) based on a metal board having good thermal conductivity.

Referring to FIG. 4, a circular PCB 210 may be provided to a substantially disk-shaped heat sink base 270 by attaching or fastening the PCB 210 to the heat sink base 270. A plurality of exhaust ports 272 may be arranged at regularly intervals along the periphery of the heat sink base 270 surrounding the circular PCB 210. The heat sink base 270 may be formed of a metallic material such as a copper or aluminum, which has good thermal conductivity.

The fan 310, for example, may be placed below the power supply unit (e.g. SMPS) and draw cold air from outside through the air suction ports (not shown) such that the suctioned air removes heat generated from the SMPS that is transferred upwards by convection while being forcibly blown downwards by the fan. Then the cold air cools the light emitting module in cooperation with the heat sink base 270 and is then finally discharged outside through the air exhaust ports 272.

Referring to FIG. 3 and FIG. 4, The PCB 210 has a positive (+) input power terminal 232, a negative (−) input power terminal 234, a positive (+) output power terminal 242, and a negative (−) output power terminal 244. The positive (+) input power terminal 232 is electrically coupled to a anode electrode of the 1^{st} LED of the LEDs 220 through a first input power pattern 236 formed on the PCB 210, and the negative (−) input power terminal 234 is electrically coupled to a cathode electrode of the n^{th} LED of the LEDs 220 through a second input power pattern 238 formed on the PCB 210. The first and second input power patterns 236, 238 may be formed on the one side (e.g. upper side) of the PCB 210 same as the circuit patterns formed on the upper side of the PCB 210.

Also, the positive (+) output power terminal 242 may be electrically coupled to a anode electrode of the 1^{st} LED of the LEDs 220 through a first output power pattern 246 formed on the PCB 210, and the negative (−) output power terminal 244 may be electrically coupled to a cathode electrode of the n^{th} LED of the LEDs 220 through a second output power pattern 248 formed on the PCB 210. The first and second output power patterns 246, 248 may be formed on the one side (e.g. upper side) of the PCB 210 in a manner similar to the circuit patterns and the first and second input power patterns 236, 238 formed on the upper side of the PCB 210. However, this is merely one embodiment, and the present invention is not necessarily limited thereto. For example, the negative (−) output power terminal 244 can be electrically coupled to a cathode electrode of the j^{th} LED (j<n) of the LEDs 220 through a second output power pattern 248 formed on the PCB 210.

As shown in FIG. 3, a pair of first power lines 205 from the power supply unit 100 may connect with the positive (+) input terminal 232 and the negative (−) input power terminal 234, and a pair of connection wires 307 connected to the fan 310 may connect with the positive (+) output power terminal 242 and the negative (−) output power terminal 244.

Specifically, the LEDs 220 connected in series are electrically coupled to the positive (+) input power terminal 232 and the negative (−) input power terminal 234 through the first input power pattern 236, the second input power pattern 238 formed on the PCB. Therefore, the constant DC current from the power supply unit 100 may be applied to the LEDs 220 in the light emitting module 200 by the input power terminals 232, 234 and the input power patterns 236, 238.

Also, the fan 310 in the fan module 300 may be electrically coupled to the LEDs 220 through the output power terminals 242, 244 and output power patterns 246, 248. That is, a positive (+) terminal of the fan 310 may be electrically coupled to the anode electrode of the 1^{st} LED of the LEDs 220 through the positive (+) output power terminal 242 and the first out power pattern 246 formed on the PCB 210. Likewise, a negative (−) terminal of the fan 310 may be electrically coupled to the cathode electrode of the n^{th} LED of the LEDs 220 through negative (−) output power terminal 244 and the second out power pattern 248 formed on the PCB 210. Therefore, the constant DC voltage, which is the sum of the forward voltages of the LEDs 220, may be applied to the fan 310 through the output power terminals 242, 244 and the output power patterns 246, 248.

Each of the LEDs 220 has a forward voltage (Vf) and, in general, the forward voltage of the each LED may be the same. Thus, a sum of the forward voltage of the whole LEDs (1^{st} LED, 2^{nd} LED, . . . , n^{th} LED) may be n*Vf Volts. For example, if the Vf of LED is a 1 Volt (V) and the number of the LEDs is 10, the sum of the Vf of the whole group of LEDs may be 10V.

The fan 310 should preferably be applied constant DC voltage for working, and the level of the DC voltage applied to the fan 310 may be determined according to the requirements of the fan 310. If the working voltage level of the fan 310 is lower than the sum of the Vf of the LEDs 220, the sum of the Vf of the LEDs 220 can be applied to the fan 310. In other words, the voltage level of the sum of the Vf may be higher than the level of the working voltage of the fan 310.

For example, if the working voltage of the fan 310 is the 9V, and the sum of the forward voltages of LEDs is 10 V, the sum of the forward voltages can be applied to the fan 310 as a power source.

Furthermore, if the working voltage of the fan 310 is the 6V, it does not need to use the sum of the Vf of the whole group of the LEDs 220. In this case, the second output power pattern 248 can be electrically coupled between a cathode electrode of the 7^{th} LED and the negative (−) output power terminal 244, and according to this connection, the sum of the Vf the LEDs is 7V.

Therefore, if the working voltage of the fan 310 is the 6V, the sum of the forward voltages of LEDs (e.g. 7V) can be applied to the fan 310 as a power source. That is, the connection region where the second output power pattern 248 disposed can be adjusted by the working voltage of the fan 310.

As described above, RPM of the fan 310 should be controlled according to the ambient air temperature. That is, when the ambient air temperature is higher than the reference temperature, the RPM of the fan may be increased in order to maintain a suitable temperature of the light emitting module. In contrast, when the ambient air temperature is lower than the reference temperature, the RPM of the fan may remain constant or be decreased because the temperature of the light emitting module is not so high as to required being cooled down artificially.

Thus, the fan driving controller 320 may control the rotation speed of the fan 310 based upon the temperature information provided by a temperature sensor. For example, when the temperature information is provided to the fan driving controller 320, the temperature information may be converted to a control signal to control the rotation speed of the fan 310 by using pull-up resistors (not shown) in the fan driving controller 320. The control signal may be a detection voltage. The detection voltage may be varied according to the ambient air temperature. For example, if the ambient air temperature is increased, the detection voltage may be decreased.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A light emitting diode (LED) lighting apparatus, comprising:
a power supply unit configured to provide a constant direct current (DC) current;
a light emitting module comprising a printed circuit board (PCB) and a plurality of LEDs disposed on a first side of the PCB, wherein the light emitting module is configured to receive the constant DC current; and
a fan module configured to receive a constant DC voltage from the light emitting module,
wherein the constant DC voltage is a sum of forward voltages of at least two LEDs of the plurality of LEDs.

2. The LED lighting apparatus of claim 1, wherein the power supply unit comprises a switching mode power supply (SMPS) configured to convert alternating current (AC) voltage into converted DC voltage, and a light emitting driving controller configured to apply a substantially constant DC current to the light emitting module.

3. The LED lighting apparatus of claim 2, wherein the SMPS includes an AC/DC converter configured to convert an AC voltage from an external source to a DC voltage, and a DC/DC converter configured to convert the converted DC voltage to a first DC voltage.

4. The LED lighting apparatus of claim 3, wherein the light emitting driving controller is electrically coupled to the DC/DC converter and is configured to maintain the constant DC current applied to the light emitting module by controlling the first DC voltage.

5. The LED lighting apparatus of claim 1, wherein the PCB is a metal core PCB (MCPCB) or metal PCB (MPCB) based on a metal board.

6. The LED lighting apparatus of claim 1, wherein the plurality of LEDs are connected in series each other.

7. The LED lighting apparatus of claim 6, wherein the PCB has a positive (+) input power terminal and a negative (−) input power terminal electrically coupled to the power supply unit.

8. The LED lighting apparatus of claim 7, wherein the positive (+) input power terminal is electrically coupled to an anode electrode of a first LED of the plurality of LEDs through a first input power pattern formed on the PCB, and the negative (−) input power terminal is electrically coupled to a cathode electrode of a last LED of the plurality of LEDs through a second input power pattern formed on the PCB.

9. The LED lighting apparatus of claim 8, wherein the first and second input power patterns are formed on a second side of the PCB.

10. The LED lighting apparatus of claim 6, wherein the PCB has a positive (+) output power terminal and a negative (−) output power terminal electrically coupled to a fan in the fan module.

11. The LED lighting apparatus of claim 10, wherein the positive (+) output power terminal is electrically coupled to a anode electrode of a first LED of the plurality of LEDs through a first output power pattern formed on the PCB, and the negative (−) output power terminal is electrically coupled to a cathode electrode of a j^{th} (1<j≦n) LED of the plurality of LEDs through a second output power pattern formed on the PCB.

12. The LED lighting apparatus of claim 11, wherein the first and second output power patterns are formed on a second side of the PCB.

13. The LED lighting apparatus of claim 11, wherein a sum of forward voltages from the first LED to the j^{th} LED is configured to be applied to the fan module through the positive (+) and negative (−) output power terminals and the first and second output power patterns.

14. The LED lighting apparatus of claim 13, wherein the sum of the forward voltages is the constant DC voltage applied to the fan.

15. The LED lighting apparatus of claim 14, wherein a voltage level of the sum of the forward voltages is higher than a working voltage level of the fan.

16. The LED lighting apparatus of claim 1, wherein the plurality of LEDs are disposed apart from each other on the first side of the PCB, and electrically coupled to each other with circuit patterns formed on a second side of the PCB.
